(19) United States
(12) Patent Application Publication
(10) Pub. No.: US 2016/0293080 A1
(43) Pub. Date: Oct. 6, 2016

(54) METHOD OF RAISING WRGB COLOR SATURATION

(71) Applicant: SHENZHEN CHINA STAR OPTOELECTRONICS TECHNOLOGY CO., LTD., Shenzhen, Guangdong (CN)

(72) Inventor: Yong FAN, Shenzhen, Guangdong (CN)

(73) Assignee: Shenzhen China Star Optoelectronics Technology Co., Ltd., Shenzhen, Guangdong (CN)

(21) Appl. No.: 14/429,771

(22) PCT Filed: Aug. 21, 2014
(86) PCT No.: PCT/CN2014/084874

§ 371 Date: Mar. 19, 2015

(30) Foreign Application Priority Data
Aug. 12, 2014 (CN) 201410393165.X

(51) Int. Cl. G09G 3/20; G09G 3/36

(52) U.S. Cl. CPC G09G 3/2003; G09G 3/2011; G09G 3/2074; G09G 3/36; G09G 2300/0452; G09G 2320/0666; G09G 2340/06

(57) ABSTRACT

The present invention provides a method of raising WRGB color saturation, comprising steps of: step 1, inputting original WRGB signals; step 2, converting the original RGB signals into HSV color space; step 3, implementing transformation to S, V to obtain new HS′V′ color space, and enhancing color saturation; step 4, implementing conversion process to HS′V′ obtained in the third step to obtain R′G′B′ signals; step 5, implementing conversion process to the R′G′B′ signals obtained in the fourth step to obtain W″R″ G″ B″ signals; step 6, outputting the W″R″ G″ B″ signals. The method can promote the color saturation of a liquid crystal display panel to make the display effect more vivid and display quality better. It resolves the issues that the gray scale change is not smooth and water mark phenomenon appears in some gray scales in WRGB skill according to prior art.

### FIELD OF THE INVENTION

The present invention relates to a display technology field, and more particularly to a method of raising WRGB color saturation.

### BACKGROUND OF THE INVENTION

Liquid Crystal Display (LCD), Organic Light Emitting Diode (OLED) and other flat panel displays have been gradually replaced the CRT displays and become a mainstream of the display devices. A display panel is an important component of LCD, OLED and other flat panel displays. For a LCD, the structure of the liquid crystal display comprises a Color Filter (CF) substrate, a Thin Film Transistor Array Substrate (TFT Array Substrate), and a Liquid Crystal Layer located between the two substrates. The working principle is that the light of backlight module is reflected to generate images by applying driving voltages to the two glass substrate for controlling the rotations of the liquid crystal molecules.

A traditional liquid crystal display panel comprises a plurality of pixels arranged as a matrix array. Each of the pixels further comprises three sub pixels, Red (R), Green (G) and Blue (B). All the R, G, B color filters in prior arts are absorption-type color filters. When the light is incident, only the light of the corresponding color can transmit therethrough. The lights of other two colors will be absorbed. Therefore, the light transmittance of the display panel becomes lower. Consequently, a display technology of forming four sub pixels of red, green, blue and white (W) in one pixel came to the market. The W sub pixel does not added with any color filters and the light transmittance of the display panel can be raised by regulating the corresponding gray scale of the white sub pixel to control the transmitting quantity of light thereof. At present, the display panel having four WRGB sub pixels has been widely utilized in a LCD display. However, with the addition of the W sub pixel, the saturation (S) of the color image observed by human eyes is decreased. The color will be not vivid enough and condition of efflorescence may appear on the displayed image.

A WminRGB algorithm is the most commonly used algorithm to convert the RGB signals to the WRGB signals. The calculation of the algorithm is simple but lacking of proper conversion of value and gray scale. Therefore, the saturation of the image is worse. Even sinusoidal function S′=Sin(π/2×S) is utilized to enhance the actual saturation S to S′. The enhancing effect of the saturation of the Ultimate image is not so obvious. Please refer to FIG. 4, the issues that the gray scale change is not smooth and water mark phenomenon appears in some gray scales exist after the Samsung tech is employed to convert RGB to WRGB.

Therefore, the saturation of the liquid crystal display panel needs to be enhanced in advance to raise the value for achieving a better display effect.

The HSV (Hue, Saturation, Value) color model is tied up with the enhanced saturation. It creates a color space according to the intuitive characteristics of colors and so called a hexcone model. The color parameters in this model respectively are: Hue (H), Saturation (S), Value (V). Hue is calibrated according to the angel and the valuing range is 0°-360°. The valuing range of the Saturation is 0.0-1.0. The valuing range of the value is 0.0 (black)-1.0 (white).

### SUMMARY OF THE INVENTION

An objective of the present invention is to provide a method of raising WRGB color saturation to promote the color saturation of a liquid crystal display panel to make the display effect more vivid and display quality better. It resolves the issues that the gray scale change is not smooth and water mark phenomenon appears in some gray scales in WRGB skill according to prior art.

For realizing the aforesaid objective, the present invention provides method of raising WRGB color saturation, comprising steps of:

step 1, inputting original WRGB signals;

step 2, converting the original RGB signals into HSV color space;

H represents hue, and S represents saturation, and V represents value;

step 3, implementing transformation to S, V to obtain new HS′V′ color space, and enhancing color saturation;

the transformation formulas are:

$${S}^{′} ( S ) = \frac{N \times ( 1 + N )}{{( \frac{N \times ( 1 + N )}{{( s - 1 )}^{2} + N} - N - 1 )}^{2} + N} - N$$

$${V}^{′} ( V ) = \frac{M \times ( 1 + M )}{{( \frac{M \times ( 1 + M )}{{( v - 1 )}^{2} + M} - M - 1 )}^{2} + M} - M$$

S′ represents color saturation after transformation, and V′ represents value after transformation, and s, v respectively are values corresponding to S, V, and N is a constant larger than 1, and M is a constant larger than 1;

step 4, implementing conversion process to HS′V′ obtained in the step 3 to obtain R′G′B′ signals;

step 5, implementing conversion process to the R′G′B′ signals obtained in the step 4 to obtain W″R″ G″ B″ signals;

the W″ signal is a signal corresponding to blank sub pixels;

step 6, outputting the W″R″ G″ B″ signals.

in the step 2 of converting the original RGB signals into HSV color space, the employed conversion formulas are:

$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 , & if max = 0 \\ \frac{max - min}{max} = 1 - \frac{min}{max} , & otherwise\end{matrix} \\ v = max$$

h, s, v respectively are values corresponding to H, S, V, and r represents a value of a R sub pixel, and g represents a value of a G sub pixel, and b represents a value of a B sub pixel, and max=max (r, g, b), and min=min (r, g, b).

The constants N and M in the step 3 are equal or unequal.

In the step 4 of implementing conversion process to HS′V′ to obtain the R′G′B′ signals, the employed conversion formulas are:

$${h}_{i} = ⌊ \frac{h}{60} ⌋ ( mod 6 )$$

$$f = \frac{h}{60} - {h}_{i}$$

$$p = {v}^{′} \times ( 1 - {s}^{′} )$$

$$q = {v}^{′} \times ( 1 - f \times {s}^{′} )$$

$$t = {v}^{′} \times ( 1 - ( 1 - f ) \times {s}^{′} )$$

$$( {R}^{′} , {G}^{′} , {B}^{′} ) = \{ \begin{matrix}( v , t , p ) & {ifh}_{i} = 0 \\ ( q , v , p ) & {ifh}_{i} = 1 \\ ( p , v , t ) & {ifh}_{i} = 2 \\ ( p , q , v ) & {ifh}_{i} = 3 \\ ( t , p , v ) & {ifh}_{i} = 4 \\ ( v , p , q ) & {ifh}_{i} = 5\end{matrix}$$

h, v′, s′ respectively are a value corresponding to H, and values of V′, S′ after transformation in the step 3.

A WminRGB algorithm is utilized to obtain the W″ signal in the step 5 and the W″ signal is taken to be a minimum gray scale of the R″ G″ B″ signals.

A method of raising WRGB color saturation, comprising steps of:

step 1′, inputting original WRGB signals;

step 2′, implementing conversion process to the original RGB signals to obtain W′R′ G′ B′ signals;

the W′ signal is a signal corresponding to blank sub pixels;

step 3′, converting the R′ G′ B′ signals into HSV color space;

H represents hue, and S represents saturation, and V represents value;

step 4′, implementing transformation to S, V to obtain new HS′V′ color space, and enhancing color saturation;

the transformation formulas are:

$${S}^{′} ( S ) = \frac{N \times ( 1 + N )}{{( \frac{N \times ( 1 + N )}{{( s - 1 )}^{2} + N} - N - 1 )}^{2} + N} - N$$

$${V}^{′} ( V ) = \frac{M \times ( 1 + M )}{{( \frac{M \times ( 1 + M )}{{( v - 1 )}^{2} + M} - M - 1 )}^{2} + M} - M$$

S′ represents color saturation after transformation, and V′ represents value after transformation, and s, v respectively are values corresponding to S, V, and N is a constant larger than 1, and M is a constant larger than 1;

step 5′, implementing conversion process to HS′V′ obtained in the step 4′ to obtain R″G″B″ signals;

step 6′, outputting the W″R″ G″ B″ signals.

A WminRGB algorithm is utilized to obtain the W′ signal in the step 2′, and the W′ signal is taken to be a minimum gray scale of the R′G′B′ signals.

In the step 3′ of converting the R′G′B′ signals into HSV color space, the employed conversion formulas are:

$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 , & if max = 0 \\ \frac{max - min}{max} = 1 - \frac{min}{max} , & otherwise\end{matrix} \\ v = max$$

h, s, v respectively are values corresponding to H, S, V, and r represents a value of a R sub pixel corresponding to the R′ signal after conversion, and g represents a value of a G sub pixel corresponding to the G′ signal after conversion, and b represents a value of a B sub pixel corresponding to the B′ signal after conversion, and max=max (r, g, b), and min=min (r, g, b).

The constants N and M in the step 4′ are equal or unequal.

In the step 5′ of implementing conversion process to HS′V′ to obtain the R″G″B″ signals, the employed conversion formulas are:

$${h}_{i} = ⌊ \frac{h}{60} ⌋ ( mod 6 )$$

$$f = \frac{h}{60} - {h}_{i}$$

$$p = {v}^{′} \times ( 1 - {s}^{′} )$$

$$q = {v}^{′} \times ( 1 - f \times {s}^{′} )$$

$$t = {v}^{′} \times ( 1 - ( 1 - f ) \times {s}^{′} )$$

$$( {R}^{′} , {G}^{′} , {B}^{′} ) = \{ \begin{matrix}( v , t , p ) & {ifh}_{i} = 0 \\ ( q , v , p ) & {ifh}_{i} = 1 \\ ( p , v , t ) & {ifh}_{i} = 2 \\ ( p , q , v ) & {ifh}_{i} = 3 \\ ( t , p , v ) & {ifh}_{i} = 4 \\ ( v , p , q ) & {ifh}_{i} = 5\end{matrix}$$

h, v′, s′ respectively are a value corresponding to H, and values of V′, S′ after transformation in the step 4′.

The benefits of the present invention are: according to a method of raising WRGB color saturation of the present invention, by implementing transformation to the color saturation S and value V in the HSV color space to enhance the color saturation, it is capable of promote the color saturation of a liquid crystal display panel to make the display effect more vivid and display quality better. It resolves the issues that the gray scale change is not smooth and water mark phenomenon appears in some gray scales in WRGB skill according to prior art.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In Drawings:

FIG. 1 is a flowchart showing an embodiment of a method of raising WRGB color saturation according to the present invention;

FIG. 2 is a flowchart showing another embodiment of a method of raising WRGB color saturation according to the present invention;

FIG. 3 is a curvilinear correlation diagram of an obtained color saturation S′ by a method of raising WRGB color saturation according to the present invention and original color saturation S;

FIG. 4 is a gray scale comparison diagram of a method of raising WRGB color saturation according to the present invention with prior art.

### DETAILED DESCRIPTION OF PREFERRED EMBODIMENTS

Embodiments of the present invention are described in detail with the technical matters, structural features, achieved objects, and effects with reference to the accompanying drawings as follows.

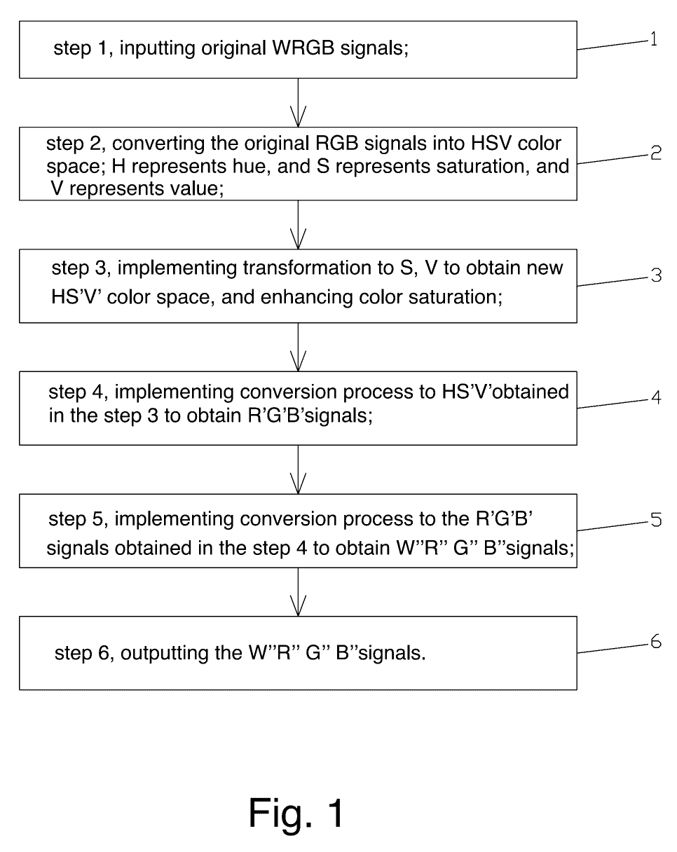

Please refer to FIG. 1, which is a flowchart showing an embodiment of a method of raising WRGB color saturation according to the present invention, comprising steps of:

step 1, inputting original WRGB signals.

step 2, converting the original RGB signals into HSV color space.

H represents hue, and S represents saturation, and V represents value.

the conversion formulas employed in step 2 are:

$$\begin{matrix}h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} & ( 1 ) \\ s = \{ \begin{matrix}0 , & if max = 0 \\ \frac{max - min}{max} = 1 - \frac{min}{max} , & otherwise\end{matrix} & ( 2 ) \\ v = max & ( 3 )\end{matrix}$$

in which: h, s, v respectively are values corresponding to H, S, V, and r represents a value of a R sub pixel, and g represents a value of a G sub pixel, and b represents a value of a B sub pixel, and max=max (r, g, b), and min=min (r, g, b).

step 3, implementing transformation to S, V to obtain new HS′V′ color space, and enhancing color saturation.

the transformation formulas employed in step 3 are:

$$\begin{matrix}{S}^{′} ( S ) = \frac{N \times ( 1 + N )}{{( \frac{N \times ( 1 + N )}{{( s - 1 )}^{2} + N} - N - 1 )}^{2} + N} - N & ( 4 ) \\ {V}^{′} ( V ) = \frac{M \times ( 1 + M )}{{( \frac{M \times ( 1 + M )}{{( v - 1 )}^{2} + M} - M - 1 )}^{2} + M} - M & ( 5 )\end{matrix}$$

in which: S′ represents color saturation after transformation, and V′ represents value after transformation, and s, v respectively are values corresponding to S, V, and N is a constant larger than 1, and M is a constant larger than 1. N and M are equal or unequal.

Various color saturation S′, value V′ can be obtained with transformation to realize various color simulation effect by adjusting parameters N, M in formula (3) and formula (4).

As regarding of formula (4), the basic functional form is:

$$F ( X ) = \frac{N \times ( 1 + N )}{{( x - 1 )}^{2} + N} - N \qquad ( 6 )$$

in which: xε [0, 1].

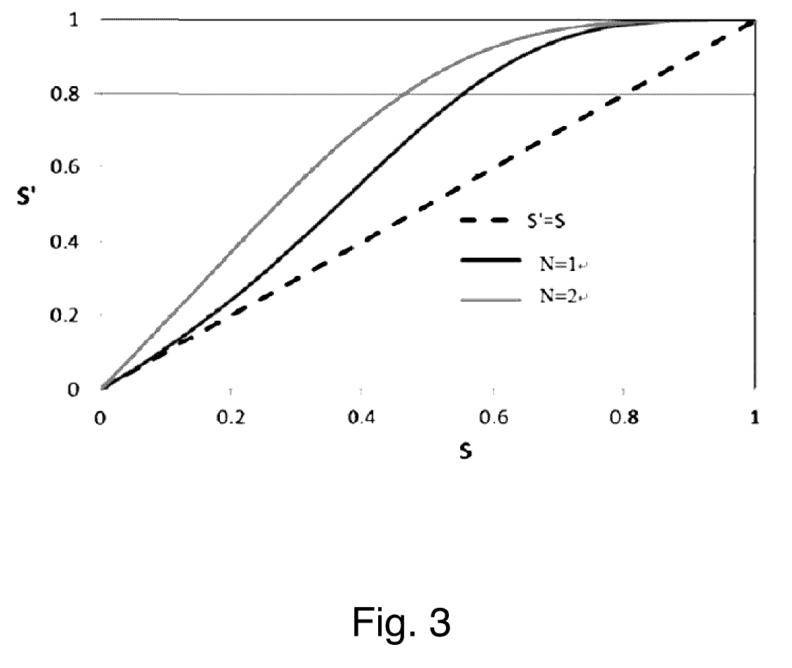

FIG. 3 is a curvilinear correlation diagram of a color saturation S′ obtained in the step 3 and original color saturation S. As shown in figure, in the range of Sε [0, 1], S′>5. The parameter N is adjustable. The larger N is, in the range of low to middle saturations (S<0.5), the difference between S′ and S is larger. The enhance effect to the low to middle saturations is more obvious, and the color is more vivid.

step 4, implementing conversion process to HS′V′ obtained in the step 3 to obtain R′G′B′ signals.

the conversion formulas employed in step 4 are:

$$\begin{matrix}{h}_{i} = ⌊ \frac{h}{60} ⌋ ( mod 6 ) \\ f = \frac{h}{60} - {h}_{i} \\ p = {v}^{′} \times ( 1 - {s}^{′} ) \\ q = {v}^{′} \times ( 1 - f \times {s}^{′} ) \\ t = {v}^{′} \times ( 1 - ( 1 - f ) \times {s}^{′} ) & ( 7 ) \\ ( {R}^{′} , {G}^{′} , {B}^{′} ) = \{ \begin{matrix}( v , t , p ) & {ifh}_{i} = 0 \\ ( q , v , p ) & {ifh}_{i} = 1 \\ ( p , v , t ) & {ifh}_{i} = 2 \\ ( p , q , v ) & {ifh}_{i} = 3 \\ ( t , p , v ) & {ifh}_{i} = 4 \\ ( v , p , q ) & {ifh}_{i} = 5\end{matrix} & ( 8 )\end{matrix}$$

h, v′, s′ respectively are a value corresponding to H, and values of V′, S′ after transformation in the step 3.

step 5, implementing conversion process to the R′G′B′ signals obtained in the step 4 to obtain W″R″ G″ B″ signals.

wherein the W″ signal is a signal corresponding to blank sub pixels. Specifically, a WminRGB algorithm is utilized to obtain the W″ signal in the step 5 and the W″ signal is taken to be a minimum gray scale of the R″ G″ B″ signals.

step 6, outputting the W″R″ G″ B″ signals.

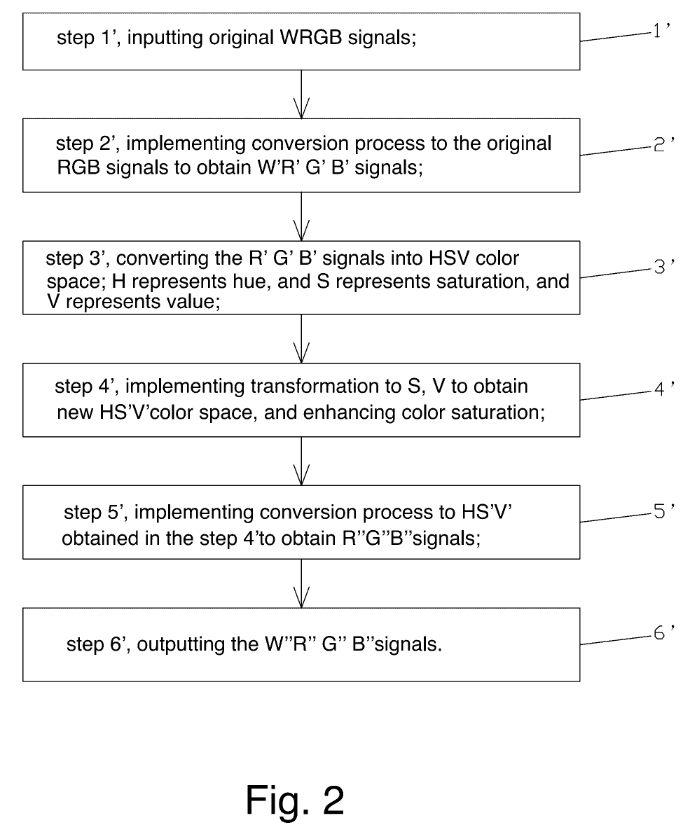

Please refer to FIG. 2, which is a flowchart showing another embodiment of a method of raising WRGB color saturation according to the present invention, comprising steps of:

step 1′, inputting original WRGB signals.

step 2′, implementing conversion process to the original RGB signals to obtain W′R′ G′ B′ signals.

wherein the W′ signal is a signal corresponding to blank sub pixels. Specifically, a WminRGB algorithm is utilized to obtain the W′ signal in the step 2′, and the W′ signal is taken to be a minimum gray scale of the R′G′B′ signals.

step 3′, converting the R′ G′ B′ signals into HSV color space.

H represents hue, and S represents saturation, and V represents value.

the conversion formulas employed in the step 3′ are:

$$\begin{matrix}h = \{ \begin{matrix}0 ° & if max = min \\ 60 ° \times \frac{g - b}{max - min} + 0 ° , & if max = r and g \geq b \\ 60 ° \times \frac{g - b}{max - min} + 360 ° , & if max = r and g < b \\ 60 ° \frac{b - r}{max - min} + 120 ° , & if max = g \\ 60 ° \times \frac{r - g}{max - min} + 240 ° , & if max = b\end{matrix} & ( {1}^{′} ) \\ s = \{ \begin{matrix}0 , & if max = 0 \\ \frac{max - min}{max} = 1 - \frac{min}{max} , & otherwise\end{matrix} & ( {2}^{′} ) \\ v = max & ( {3}^{′} )\end{matrix}$$

h, s, v respectively are values corresponding to H, S, V, and r represents a value of a R sub pixel corresponding to the R′ signal after conversion, and g represents a value of a G sub pixel corresponding to the G′ signal after conversion, and b represents a value of a B sub pixel corresponding to the B′ signal after conversion, and max=max (r, g, b), and min=min (r, g, b).

step 4′, implementing transformation to S, V to obtain new HS′V′ color space, and enhancing color saturation.

the transformation formulas employed in the step 4′ are:

$$\begin{matrix}{S}^{′} ( S ) = \frac{N \times ( 1 + N )}{{( \frac{N \times ( 1 + N )}{{( s - 1 )}^{2} + N} - N - 1 )}^{2} + N} - N & ( {4}^{′} ) \\ {V}^{′} ( V ) = \frac{M \times ( 1 + M )}{{( \frac{M \times ( 1 + M )}{{( v - 1 )}^{2} + M} - M - 1 )}^{2} + M} - M & ( {5}^{′} )\end{matrix}$$

in which: S′ represents color saturation after transformation, and V′ represents value after transformation, and s, v respectively are values corresponding to S, V, and N is a constant larger than 1, and M is a constant larger than 1. N and M are equal or unequal.

Various color saturation S′, value V′ can be obtained with transformation to realize various color simulation effect by adjusting parameters N, M in formula (3′) and formula (4′).

As regarding of formula (4′), the basic functional form is:

$$F ( X ) = \frac{N \times ( 1 + N )}{{( x - 1 )}^{2} + N} - N \qquad ( {6}^{′} )$$

in which: xε [0, 1].

FIG. 3 is a curvilinear correlation diagram of a color saturation S′ obtained in the step 4′ and original color saturation S. As shown in figure, in the range of Sε [0, 1], S′>S. The parameter N is adjustable. The larger N is, in the range of low to middle saturations (S<0.5), the difference between S′ and S is larger. The enhance effect to the low to middle saturations is more obvious, and the color is more vivid.

step 5′, implementing conversion process to HS′V′ obtained in the step 4′ to obtain R″G″B″ signals.

the conversion formulas employed in step 5′ are:

$$\begin{matrix}{h}_{i} = ⌊ \frac{h}{60} ⌋ ( mod 6 ) \\ f = \frac{h}{60} - {h}_{i} \\ p = {v}^{′} \times ( 1 - {s}^{′} ) \\ q = {v}^{′} \times ( 1 - f \times {s}^{′} ) \\ t = {v}^{′} \times ( 1 - ( 1 - f ) \times {s}^{′} ) & ( {7}^{′} ) \\ ( {R}^{″} , {G}^{″} , {B}^{″} ) = \{ \begin{matrix}( v , t , p ) & {ifh}_{i} = 0 \\ ( q , v , p ) & {ifh}_{i} = 1 \\ ( p , v , t ) & {ifh}_{i} = 2 \\ ( p , q , v ) & {ifh}_{i} = 3 \\ ( t , p , v ) & {ifh}_{i} = 4 \\ ( v , p , q ) & {ifh}_{i} = 5\end{matrix} & ( {8}^{′} )\end{matrix}$$

h, v′, s′ respectively are a value corresponding to H, and values of V′, S′ after transformation in the step 4′.

step 6′, outputting the W″R″ G″ B″ signals.

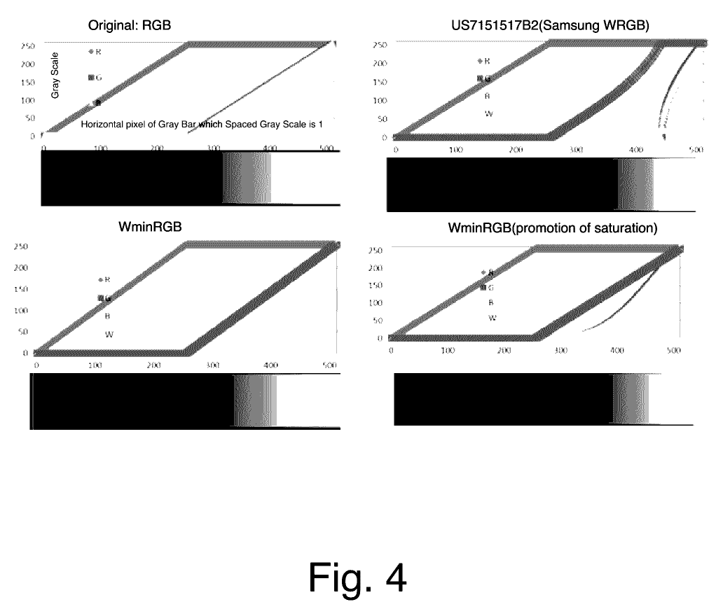

To be compared with prior arts, as performing display with the method of raising WRGB color saturation according to the present invention, the vividness of the images is tremendously promoted. Particularly, the part of skin color is closest to the original images and the display effect is the best. Please refer to FIG. 4, which is comparison of a method of raising WRGB color saturation according to the present invention with prior art. The gray scale change is smoother and no water mark phenomenon appears.

In conclusion, according to a method of raising WRGB color saturation of the present invention, by implementing transformation to the color saturation S and value V in the HSV color space to enhance the color saturation, it is capable of promote the color saturation of a liquid crystal display panel to make the display effect more vivid and display quality better. It resolves the issues that the gray scale change is not smooth and water mark phenomenon appears in some gray scales in WRGB skill according to prior art.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A method of raising WRGB color saturation, comprising steps of:
step 1, inputting original WRGB signals;
step 2, converting the original RGB signals into HSV color space;
H represents hue, and S represents saturation, and V represents value;
step 3, implementing transformation to S, V to obtain new HS′V′ color space, and enhancing color saturation;
the transformation formulas are:
$$\begin{matrix}{S}^{′} ( S ) = \frac{N \times ( 1 + N )}{{( \frac{N \times ( 1 + N )}{{( s - 1 )}^{2} + N} - N - 1 )}^{2} + N} - N \\ {V}^{′} ( V ) = \frac{M \times ( 1 + M )}{{( \frac{M \times ( 1 + M )}{{( v - 1 )}^{2} + M} - M - 1 )}^{2} + M} - M\end{matrix}$$
S′ represents color saturation after transformation, and V′ represents value after transformation, and s, v respectively are values corresponding to S, V, and N is a constant larger than 1, and M is a constant larger than 1;
step 4, implementing conversion process to HS′V′ obtained in the third step to obtain R′G′B′ signals;
step 5, implementing conversion process to the R′G′B′ signals obtained in the fourth step to obtain W″R″ G″ B″ signals;
the W″ signal is a signal corresponding to blank sub pixels;
step 6, outputting the W″R″ G″ B″ signals.

2. The method of raising WRGB color saturation according to claim 1, wherein in the second step of converting the original RGB signals into HSV color space, the employed conversion formulas are:
$$\begin{matrix}h = \{ \begin{matrix}0 ° & if max = min \\ 60 ° \times \frac{g - b}{max - min} + 0 ° , & if max = r and g \geq b \\ 60 ° \times \frac{g - b}{max - min} + 360 ° , & if max = r and g < b \\ 60 ° \frac{b - r}{max - min} + 120 ° , & if max = g \\ 60 ° \times \frac{r - g}{max - min} + 240 ° , & if max = b\end{matrix} \\ s = \{ \begin{matrix}0 , & if max = 0 \\ \frac{max - min}{max} = 1 - \frac{min}{max} , & otherwise\end{matrix} \\ v = max\end{matrix}$$
h, s, v respectively are values corresponding to H, S, V, and r represents a value of a R sub pixel, and g represents a value of a G sub pixel, and b represents a value of a B sub pixel, and max=max (r, g, b), and min=min (r, g, b).

3. The method of raising WRGB color saturation according to claim 1, wherein the constants N and M in the third step are equal or unequal.

4. The method of raising WRGB color saturation according to claim 1, wherein in the fourth step of implementing conversion process to HS′V′ to obtain the R′G′B′ signals, the employed conversion formulas are:
$$\begin{matrix}{h}_{i} = ⌊ \frac{h}{60} ⌋ ( mod 6 ) \\ f = \frac{h}{60} - {h}_{i} \\ p = {v}^{′} \times ( 1 - {s}^{′} ) \\ q = {v}^{′} \times ( 1 - f \times {s}^{′} ) \\ t = {v}^{′} \times ( 1 - ( 1 - f ) \times {s}^{′} ) \\ ( {R}^{′} , {G}^{′} , {B}^{′} ) = \{ \begin{matrix}( v , t , p ) & {ifh}_{i} = 0 \\ ( q , v , p ) & {ifh}_{i} = 1 \\ ( p , v , t ) & {ifh}_{i} = 2 \\ ( p , q , v ) & {ifh}_{i} = 3 \\ ( t , p , v ) & {ifh}_{i} = 4 \\ ( v , p , q ) & {ifh}_{i} = 5\end{matrix}\end{matrix}$$
h, v′, s′ respectively are a value corresponding to H, and values of V′, S′ after transformation in the third step.

5. The method of raising WRGB color saturation according to claim 1, wherein a WminRGB algorithm is utilized to obtain the W″ signal in the fifth step and the W″ signal is taken to be a minimum gray scale of the R″ G″ B″ signals.

6. A method of raising WRGB color saturation, comprising steps of:
step 1′, inputting original WRGB signals;
step 2′, implementing conversion process to the original RGB signals to obtain W′R′ G′ B′ signals;
the W′ signal is a signal corresponding to blank sub pixels;
step 3′, converting the R′ G′ B′ signals into HSV color space;
H represents hue, and S represents saturation, and V represents value;
step 4′, implementing transformation to S, V to obtain new HS′V′ color space, and enhancing color saturation;
the transformation formulas are:
$$\begin{matrix}{S}^{′} ( S ) = \frac{N \times ( 1 + N )}{{( \frac{N \times ( 1 + N )}{{( s - 1 )}^{2} + N} - N - 1 )}^{2} + N} - N \\ {V}^{′} ( V ) = \frac{M \times ( 1 + M )}{{( \frac{M \times ( 1 + M )}{{( v - 1 )}^{2} + M} - M - 1 )}^{2} + M} - M\end{matrix}$$
S′ represents color saturation after transformation, and V′ represents value after transformation, and s, v respectively are values corresponding to S, V, and N is a constant larger than 1, and M is a constant larger than 1;
step 5′, implementing conversion process to HS′V′ obtained in the step 4′ to obtain R″G″B″ signals;
step 6′, outputting the W″R″ G″ B″ signals.

7. The method of raising WRGB color saturation according to claim 6, wherein a WminRGB algorithm is utilized to obtain the W′ signal in the step 2′, and the W′ signal is taken to be a minimum gray scale of the R″ G″ B″ signals.

8. The method of raising WRGB color saturation according to claim 6, wherein in the step 3′ of converting the R′G′B′ signals into HSV color space, the employed conversion formulas are:
$$\begin{matrix}h = \{ \begin{matrix}0 ° & if max = min \\ 60 ° \times \frac{g - b}{max - min} + 0 ° , & if max = r and g \geq b \\ 60 ° \times \frac{g - b}{max - min} + 360 ° , & if max = r and g < b \\ 60 ° \frac{b - r}{max - min} + 120 ° , & if max = g \\ 60 ° \times \frac{r - g}{max - min} + 240 ° , & if max = b\end{matrix} \\ s = \{ \begin{matrix}0 , & if max = 0 \\ \frac{max - min}{max} = 1 - \frac{min}{max} , & otherwise\end{matrix} \\ v = max\end{matrix}$$
h, s, v respectively are values corresponding to H, S, V, and r represents a value of a R sub pixel corresponding to the R′ signal after conversion, and g represents a value of a G sub pixel corresponding to the G′ signal after conversion, and b represents a value of a B sub pixel corresponding to the B′ signal after conversion, and max=max (r, g, b), and min=min (r, g, b).

9. The method of raising WRGB color saturation according to claim 6, wherein the constants N and M in the step 4′ are equal or unequal.

10. The method of raising WRGB color saturation according to claim 6, wherein in the step 5′ of implementing conversion process to HS′V′ to obtain the R″G″B″ signals, the employed conversion formulas are:
$$\begin{matrix}{h}_{i} = ⌊ \frac{h}{60} ⌋ ( mod 6 ) \\ f = \frac{h}{60} - {h}_{i} \\ p = {v}^{′} \times ( 1 - {s}^{′} ) \\ q = {v}^{′} \times ( 1 - f \times {s}^{′} ) \\ t = {v}^{′} \times ( 1 - ( 1 - f ) \times {s}^{′} ) \\ ( {R}^{″} , {G}^{″} , {B}^{″} ) = \{ \begin{matrix}( v , t , p ) & {ifh}_{i} = 0 \\ ( q , v , p ) & {ifh}_{i} = 1 \\ ( p , v , t ) & {ifh}_{i} = 2 \\ ( p , q , v ) & {ifh}_{i} = 3 \\ ( t , p , v ) & {ifh}_{i} = 4 \\ ( v , p , q ) & {ifh}_{i} = 5\end{matrix}\end{matrix}$$
h, v′, s′ respectively are a value corresponding to H, and values of V′, S′ after transformation in the step 4′.

11. A method of raising WRGB color saturation, comprising steps of:
step 1′, inputting original WRGB signals;
step 2′, implementing conversion process to the original RGB signals to obtain W′R′ G′ B′ signals;
the W′ signal is a signal corresponding to blank sub pixels;
step 3′, converting the R′ G′ B′ signals into HSV color space;
H represents hue, and S represents saturation, and V represents value;
step 4′, implementing transformation to S, V to obtain new HS′V′ color space, and enhancing color saturation;
the transformation formulas are:
$$\begin{matrix}{S}^{′} ( S ) = \frac{N \times ( 1 + N )}{{( \frac{N \times ( 1 + N )}{{( s - 1 )}^{2} + N} - N - 1 )}^{2} + N} - N \\ {V}^{′} ( V ) = \frac{M \times ( 1 + M )}{{( \frac{M \times ( 1 + M )}{{( v - 1 )}^{2} + M} - M - 1 )}^{2} + M} - M\end{matrix}$$
S′ represents color saturation after transformation, and V′ represents value after transformation, and s, v respectively are values corresponding to S, V, and N is a constant larger than 1, and M is a constant larger than 1;
step 5′, implementing conversion process to HS′V′ obtained in the step 4′ to obtain R″G″B″ signals;
step 6′, outputting the W″R″ G″ B″ signals;
wherein a WminRGB algorithm is utilized to obtain the W′ signal in the step 2′, and the W′ signal is taken to be a minimum gray scale of the R′ G′ B′ signals;
wherein in the step 3′ of converting the R′G′B′ signals into HSV color space, the employed conversion formulas are:
$$\begin{matrix}h = \{ \begin{matrix}0 ° & if max = min \\ 60 ° \times \frac{g - b}{max - min} + 0 ° , & if max = r and g \geq b \\ 60 ° \times \frac{g - b}{max - min} + 360 ° , & if max = r and g < b \\ 60 ° \frac{b - r}{max - min} + 120 ° , & if max = g \\ 60 ° \times \frac{r - g}{max - min} + 240 ° , & if max = b\end{matrix} \\ s = \{ \begin{matrix}0 , & if max = 0 \\ \frac{max - min}{max} = 1 - \frac{min}{max} , & otherwise\end{matrix} \\ v = max\end{matrix}$$
h, s, v respectively are values corresponding to H, S, V, and r represents a value of a R sub pixel corresponding to the R′ signal after conversion, and g represents a value of a G sub pixel corresponding to the G′ signal after conversion, and b represents a value of a B sub pixel corresponding to the B′ signal after conversion, and max=max (r, g, b), and min=min (r, g, b);
wherein the constants N and M in the step 4′ are equal or unequal;
wherein in the step 5′ of implementing conversion process to HS′V′ to obtain the R″G″B″ signals, the employed conversion formulas are:
$$\begin{matrix}{h}_{i} = ⌊ \frac{h}{60} ⌋ ( mod 6 ) \\ f = \frac{h}{60} - {h}_{i} \\ p = {v}^{′} \times ( 1 - {s}^{′} ) \\ q = {v}^{′} \times ( 1 - f \times {s}^{′} ) \\ t = {v}^{′} \times ( 1 - ( 1 - f ) \times {s}^{′} ) \\ ( {R}^{″} , {G}^{″} , {B}^{″} ) = \{ \begin{matrix}( v , t , p ) & {ifh}_{i} = 0 \\ ( q , v , p ) & {ifh}_{i} = 1 \\ ( p , v , t ) & {ifh}_{i} = 2 \\ ( p , q , v ) & {ifh}_{i} = 3 \\ ( t , p , v ) & {ifh}_{i} = 4 \\ ( v , p , q ) & {ifh}_{i} = 5\end{matrix}\end{matrix}$$
h, v′, s′ respectively are a value corresponding to H, and values of V′, S′ after transformation in the step 4′.
